(19) United States
(12) Patent Application Publication
(10) Pub. No.: US 2005/0072717 A1
(43) Pub. Date: Apr. 7, 2005

(54) Sieving apparatus

(75) Inventors: Rupesh Purohit, Watford (GB); Bruce John Walsh, Woking (GB)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(73) Assignee: Russell Finex Limited, Middlesex (GB)

(21) Appl. No.: 10/490,329

(22) PCT Filed: Sep. 20, 2002
(86) PCT No.: PCT/GB02/04288

(30) Foreign Application Priority Data
Sep. 21, 2001 (GB) 0122852.7

(51) Int. Cl. B07B 1/28; B07B 1/42

(52) U.S. Cl. 209/309; 209/365.1

(57) ABSTRACT

A sieve (10) has abase (3), a sieve screen frame (4) and a sieve screen (12) mounted in the frame so as to be substantially horizontal. A first vibrator (1) vibrates the frame relative to the base in a generally horizontal direction at a first frequency less than 400 Hz. A second vibrator (2) has a vibration transmission member (6) attached directly to the sieve screen and an excitation source which activates the vibration transmission member to vibrate the sieve screen (12) relative to the frame (14) in substantially vertical direction at a second frequency less than 400 Hz. The resulting activity of the screen reduces blinding in use.

### FIELD OF THE INVENTION

The present invention relates to sieving apparatus in which the sieving surface(s) (sieve screen) is vibrated at sub-ultrasonic frequencies to improve sieving performance.

### BACKGROUND OF THE INVENTION

Most industrial sieving machines include some means of applying a primary vibratory movement to the sieving screen in order to facilitate product movement through the screen and to move product which is below or above the screen aperture size around the screen, so that maximum utilisation of the active screening area is obtained and oversized product can be transported to an oversize outlet to be removed. The primary vibratory movement is often a combination of horizontal and vertical reciprocating motion of the order of a few millimetres, is typically applied essentially to the entire sieving machine, and has been provided by a variety of means.

However, this primary motion is often insufficient to prevent blinding, which is the clogging up of the sieving apertures, either by an accumulation of particles smaller than the aperture size, or by particles just above the aperture size, or by a combination of the two. Blinding is a significant problem in the industrial sieving of both powders and liquids. In an attempt to overcome the blinding problem, many methods of applying a secondary vibration to the screen have been devised over the years, with varying degrees of success.

One method of providing secondary vibration has been the provision of cylindrical sliders, or spherical balls, contained in a tray below the mesh. This is effective for the sieving of some products, but is noisy, causes more rapid mesh wear and may contaminate the products as the sliders or balls wear.

Another approach has been the introduction of ball bearings into the frame to which the mesh is attached, and which as a result of the primary motion impact against the frame thus transmitting shock waves to the mesh. Again this is noisy, and has little commercial exploitation.

A more successful approach has been to supply ultrasonic energy to the mesh. Typical ultrasonic frequencies are above 20 KHz, and typical amplitudes of the ultrasonic vibrations supplied to the mesh are a few (1-10) microns. Whilst this is more effective than the other prior art methods referred to above, it is more expensive, requires greater operator skill, and requires relatively high voltages which makes it inappropriate in potentially explosive atmospheres which prevail when sieving some products. Furthermore, it is less effective for mesh aperture sizes over 1 mm, and ultrasonic energy is quickly dissipated in the screen, making it difficult to excite a large screen area ultrasonically.

Also, ultrasonic excitation typically results in a resonance pattern being set up on the screen, with nodes and antinodes. This can cause patterned marking or wearing (in the form of concentric circles for example) of the screen after prolonged use.

We have determined a further problem with ultrasonic excitation of mesh screens. Ultrasonic vibrations propagate better (i.e. with less attenuation) in directions along the screen which are parallel to one of the sets of wires. Along directions which are not parallel to any of the component wires of the mesh, the attenuation is greater. What this means in practice is that for a circular screen comprising a rectangular mesh of wires, ultrasonically excited at its centre, the excitation is effective at preventing blinding over a cruciform region, centred on the ultrasonic source and with arms extending along the wire directions, but is less effective at preventing blinding in the quadrants between those arms. In other words, the mesh construction results in anisotropic ultrasonic attenuation characteristics, and hence results in non-uniform vibrational energy distribution over the screen area when using a single ultrasonic source.

U.S. Pat. No. 4,482,455 discloses a dual frequency vibratory screen in which a primary vibration in the horizontal direction, of typical frequency 300 rpm (5 Hz) and amplitude 2″ (5 cm) and a secondary vibration in the vertical direction, of typical frequency 3000-4000 rpm (50-67 Hz) and amplitude of approximately ¼ (0.64 cm), are applied to the sieve screen frame. However, this apparatus is large and unwieldy, and in use consumes a relatively large amount of power.

U.S. Pat. No. 5,232,099 discloses classifying apparatus with rectangular screens. Vibration motors apply high frequency, low amplitude vibrations (1000-7000 rpm, i.e. about 17-117 Hz) directly to the screen by means of tappets. The screens are longitudinally tensioned over the tappets. Further vibration motors apply low frequency, high amplitude (900-3600 rpm, i.e. about 15-60 Hz) to the screen deck.

### SUMMARY OF THE INVENTION

It is an object of the present invention to provide a sieve which overcomes, at least partially, one or more of the problems associated with the prior art sieves.

According to the present invention there is provided a sieve comprising: a base; a sieve screen frame; a sieve screen mounted in the frame so as to be substantially horizontal; a first vibrator arranged to vibrate the frame relative to the base in a horizontal direction and at a first frequency; and a second vibrator having a vibration transmission member attached directly to the sieve screen and an excitation source arranged to activate said vibration transmission member so as to vibrate the sieve screen relative to the frame in a substantially vertical direction and at a second frequency, the first and second frequencies being less than 400 Hz.

The vibration imparted to the frame relative to the base by the first vibrator may be substantially confined to a horizontal plane, or may have a substantial component in the vertical direction also. In a preferred embodiment, the first vibrator imparts primary motion to the frame, that motion being a combination of horizontal and vertical motion to facilitate distribution of product around the screen and removal of oversize particles.

The present invention does not use ultrasonic techniques to vibrate the sieve screen; 400 Hz is almost two orders of magnitude below the ultrasonic threshold.

Surprisingly, direct secondary vertical vibration of the screen at frequencies below 400 Hz has been found to be effective at preventing/reducing blinding in applications where previously only the ultrasonic techniques were thought to provide adequate performance. Use of frequencies below 400 Hz also results in more even distribution of vibrational energy over the entire screen area; it solves the problems of patterned staining/wearing and anisotropic energy distribution associated with ultrasonic techniques. Below 400 Hz, the screen is well away from resonance and all points move substantially in phase. A circular screen, excited centrally, will undergo conical secondary vertical vibrations.

The second vibrator directly excites the screening surface, imparting vertical vibrations to the screen relative to the screen frame which holds it. This direct exciting of the screen is in contrast to indirect exciting, where, for example, vibrations are transmitted to the sieve screen by vibrating the sieve screen frame.

This direct excitation of the sieve screen in the vertical direction is advantageous because it requires reduced power consumption compared with prior art systems in which vertical screen vibration was achieved by appropriate vibration of the screen frame.

In the sieve of the present invention, the horizontal vibration is particularly effective at distributing material around the sieve screen, and the vertical vibration is particularly effective at inhibiting blinding.

Direct vertical excitation of the screen at frequencies below 400 Hz (and particularly in the region of 100-150 Hz) has been found to be particularly effective, offering greatly improved anti-blinding performance compared with prior art systems in which vertical vibration was applied indirectly, via the screen frame.

Furthermore, because the vibration transmission member of the second vibrator is attached to the screen, screen wear is reduced.

Preferably, the first and second frequencies are different from one another, and more preferably one is not a harmonic of the other.

Advantageously, the second frequency may be higher than the first, and may be higher by an order of magnitude or more.

In preferred embodiments, one or both of the first and second frequencies may be adjustable, so that the sieve can be tuned/adjusted to give optimum performance for a given product.

Preferably, the first frequency is in the range 15-60 Hz.

Preferably, the second frequency exceeds 100 Hz.

The amplitudes of the horizontal and vertical vibrations applied to the sieve screen may be the same, but in certain preferred embodiments will be different from one another.

In a particularly preferred embodiment, the amplitude of the vertical vibrations at the second frequency is smaller than the amplitude of the horizontal vibrations at the first frequency, and may be smaller by a factor of ten or more. However, the amplitude of these vertical vibrations is larger than typical amplitudes of prior art ultrasonic secondary vibrations by one or more orders of magnitude.

The amplitudes of the horizontal and/or vertical vibrations may, preferably, be adjustable.

The amplitude will, in general, be selected/adjusted to suit the product and screen aperture size.

In certain embodiments, where the screen frame undergoes primary motion which is a combination of horizontal and vertical motion, the amplitude of the primary vertical vibration may be smaller than the secondary vertical vibration caused by the second vibrator. This is typical of certain compact types of sieve where the primary movement is substantially horizontal, with very little vertical.

Advantageously, the second vibrator may comprise a pneumatic actuator. This is particularly advantageous in applications where the use of an electrical actuator could pose a fire or explosion risk.

In alternative embodiments, electrically powered actuators may of course be used in the second vibrator. Thus, mechanical, electromechanical, pneumatic and other forms of actuators may be used in the second vibrators of embodiments of the present invention.

Advantageously, the second vibrator may comprise an actuator including a rotating or reciprocating weight.

In embodiments of the present invention, the excitation source of the second vibrator may be coupled directly to the transmission member. However, alternatively, the excitation source may not be attached to the vibration transmission member. Then, the source may have a striking surface arranged to strike the vibration transmission member when the source is energised.

In certain preferred embodiments the transmit member comprises a circular portion with a planar face secured to the sieve screen by suitable means.

Depending on the strength of the sieve screen and the weight of the second vibrator, the second vibrator may be wholly supported by the screen (i.e. hung from, or resting on the screen) or may be supported at least partially by rigid coupling to the frame or the fixed base.

In certain preferred arrangements, the second vibrator may comprise a plurality of excitation sources. Thus, the sieve screen may be directly excited over a large part, or indeed all, of its active screening area. Excitement over a large area can also be achieved by use of a suitably extended transmission member, driven for example by a single exciter.

The “sieve screen” may comprise a number of layers, for example it may comprise a first screen and a second screen arranged above and supported by the first. In such multi-screen sieves, one or more of the screen layers may be directly excited by the second vibrator.

For example, in one arrangement there are two screens, one being relatively coarse, and the other being relatively fine. The upper or lower screen may be directly coupled to the second vibrator, with the other screen being excited indirectly, by contact with the directly driven screen.

In certain embodiments the sieve screen may comprise two or more separate screen layers. All the layers of the multi-layer screens, and the single layer of the single layer screen may be of any screen material, e.g. stainless steel mesh, textile mesh, punched plate or any other screen material in common use.

Advantageously, the first vibrator may comprise at least one rotating weight.

The first vibrator may comprise an out-of-balance weight or weights. Other weight arrangements known in the art may be used, and in certain embodiments the first vibrator, rather than using out of balance weights, employs a direct, positively coupled eccentric drive.

Advantageously, the first vibrator may be arranged to impart gyratory motion to the frame substantially in a horizontal plane, for example to assist in distributing material around the sieve screen and to transport oversize material to an oversize chute.

Preferably, the first vibrator comprises a motor mounted such that when at rest its shaft is substantially vertical. A single eccentric weight may be rotated by the motor, or more preferably first and second weights are coupled to the upper and lower ends of the shaft respectively. Advantageously the first weight may be greater than the second weight.

Preferably, the coupling of at least one of the weights to the shaft is adjustable so that the relative positions of the weights on the shaft may be varied to optimise the primary motion.

In certain preferred embodiments the sieve screen is circular, although the present invention in its most general sense applies to all shapes and sizes of horizontal screens.

### BRIEF DESCRIPTION OF THE DRAWINGS

Embodiments of the present invention will now be described with reference to the accompanying drawings, in which:

FIG. 1 is a highly schematic diagram of a sieve in accordance with am embodiment of the present invention;

FIG. 2 is a diagram of a sieve screen and first vibrator suitable for use in embodiments of the present invention;

FIG. 3 is a plan view of a sieve screen, frame and second vibrator of a further embodiment;

FIG. 4 is a sectional view of the apparatus shown in FIG. 3;

FIG. 5 is a plan view of the screen, frame and second vibrator of a further embodiment;

FIG. 6 is a plan view of the screen, frame and second vibrator of yet a further embodiment;

FIGS. 7, 8 and 9 are perspective views of transmitters and pneumatic actuators suitable for use in embodiments of the present invention;

FIGS. 10, 11 and 12 are simplified sectional views of the direct coupling between the second vibrator and sieve screen in various embodiments of the present invention;

FIGS. 13, 14, 15, 16, 17 and 18 are sectional views of a pneumatic actuator suitable for use in embodiments of the present invention;

FIG. 19 is a perspective view of a double layer screen, its frame, and second vibrator of a further embodiment;

FIG. 20 is a schematic diagram of part of a further embodiment, showing the apparatus controlling the pneumatic actuator and transmitter of the second vibrator;

FIG. 21 is an underneath plan view of another embodiment of the invention; and

FIG. 22 is a cross-sectional view taken along line 22-22 in FIG. 21.

### DETAILED DESCRIPTION OF THE PREFERRED EMBODIMENTS

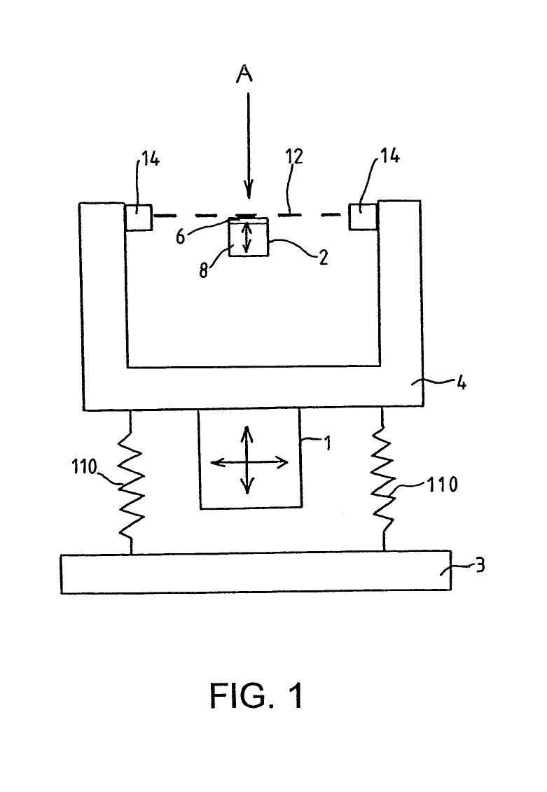

Referring now to FIG. 1, this Figure shows, in highly schematic form, a sieve 10 embodying the present invention. The sieve 10 comprises a sieve screen 12 in the form of a mesh, which is held (e.g. clamped) in a sieve screen frame 14. The screen 12 is tensioned in the frame 14 at least in two orthogonal directions, typically corresponding to the wire directions of the screen mesh. The frame 14 may be rectangular but is preferably circular. The sieve screen frame 14 is itself rigidly attached to an inner frame 4. The sieve 10 includes a fixed base 3, and the inner frame 4 is mounted on the base 3 by springs 110. A first vibrator 1 is attached to the inner frame. In use, the operation of the first vibrator in combination with the spring-mounting of the inner frame on the base results in vibratory motion being imparted to the inner frame, that motion having both horizontal and vertical components. Thus, in operation, the first vibrator vibrates the inner frame 4 in the horizontal and vertical directions in relation to the fixed base 3, and hence imparts horizontal and vertical vibrations to the screen frame 14 and the screen 12 itself. The frequency of this primary horizontal and vertical vibration is 25 Hz in this example.

Inside the inner frame 4 there is a second vibrator 2, which is attached to the screening surface 12. In use, the second vibrator 2 generates vibrations which are transmitted directly to the screen 12 and result in vertical vibration of the screen 12 relative to the frame 14 which holds it. The coupling between the second vibrator 2 and the screen 12 drives the vertical vibration of the screen 12 at a central position A. In alternative embodiments the drive/excitation may be applied at other positions relative to the screen frame, and indeed at a plurality of positions on a single screen. In use, the second vibrator 2 also undergoes the horizontal and vertical vibrations imparted to the inner frame 4 by the first vibrator 1. The vertical vibrations generated by the second vibrator 2 are communicated to the screen 12 only, and not to its frame 14. As will be explained in more detail later, the second vibrator 2 comprises a vibration transmission member 6 attached directly to the screen 12 and an excitation source 8 which activates the transmission member to vibrate the screen 12. As illustrated, the source 8 is attached to the transmission member 6, but this is not essential, as will become apparent.

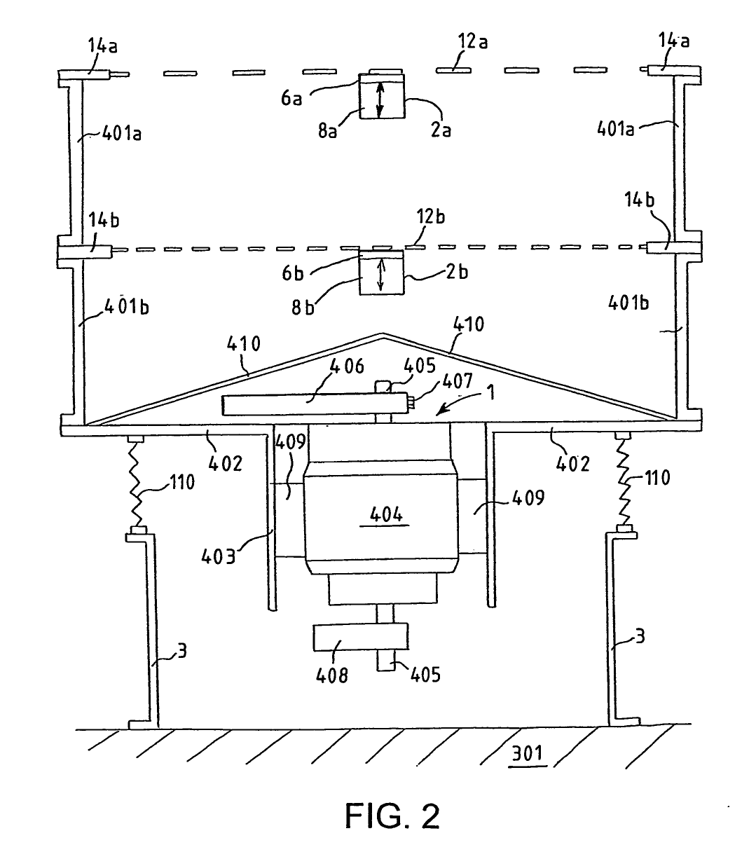

Referring now to FIG. 2, this Figure shows schematically another sieve embodying the present invention. This is a multi-deck screen, having two decks. Other embodiments may have more. An upper deck comprises a circular coarse screen 12a, radially tensioned in a circular frame 14a, which is itself supported by an annular sieve deck 401a. An upper deck secondary vibrator 2a is attached to the underside of the coarse screen 12a. For simplicity, the means by which material is supplied to and removed from the screen stack are not shown in the figure. The illustrated sieve includes a lower, fine sieve screen mesh 12, a fixed base 3 and a first vibrator 1. The illustrated apparatus is generally cylindrical. The lower sieve screen mesh 12b is also circular and is radially tensioned by a screen frame 14b in the form of a ring. A lower screen secondary vibrator 2b is attached to the underside of the screen 126. The screen frame 14b is itself supported on an annular sieve deck 401b. A lower edge of the sieve deck 401b is rigidly coupled to an upper base 402. The secondary vibrators 2a and 2b can take the same form as in the embodiment of FIG. 1, having respective transmission members 6a and 6b, and respective excitation sources 8a and 8b.

A cylindrical housing 403 extends downwards from the upper base 402 and accommodates an electrical motor 404. In this example the upper base 402 and housing 403 are integral, but in other embodiments may be fabricated from separate components, rigidly attached together (for example by welding). A cone 410 is located at the bottom of the screen stack to prevent material which has fallen through the lower screen 12b from fouling the motor 404 and rotating weight 406. The cone 410 directs the fallen material to the edge of the stack for removal. In other embodiments the “cone” may have some other suitable shape, e.g. a dome. The motor 404 is rigidly attached to the cylindrical housing 403 by means of rigid couplings 409. The shaft 405 of the motor 404, when the motor is at rest, is generally vertical. An upper eccentric weight 406 is attached to the upper end of the shaft 405 by means of a bolt 407. The position of the weight 406 on the shaft 405 is adjustable, and in particular the rotational angle at which the weight extends from the shaft in the generally horizontal plane may be varied. A second, lower weight 408 is attached to the lower end of the motor shaft 405. In this example the mass of the lower weight is less than that of the upper weight. In alternative embodiments, the mass of one or both of the weights may be adjustable, and of course the lower weight may be heavier than the upper. By means of the adjustable attachment of the upper weight to the shaft the relative angular positions of the two weights on the shaft may be varied to give optimum sieve performance for a particular application.

The sieve also includes a fixed base 3 which is attached to the factory floor 301 in this example. In alternative embodiments the base may simply rest on a suitable surface (e.g. factory floor) may be fixed to it, or may be arranged on wheeled or other mounts. The upper base 402 is supported by the fixed base 3 on springs or other resilient members 110. These springs 110 permit both horizontal and vertical movement of the upper base (and hence the sieve frames 14a and 14b and screens 12a and 12b themselves) relative to the fixed base 3. In use, the motor shaft 405 rotates and, as a result of the out of balance weights 406 and 408 generates vibratory forces. Advantageously, the weights will have different masses, and be orientated at different angles with respect to the shaft so that these vibratory forces have both horizontal and vertical components. The resultant motion of the screen 12 improves the sieving performance.

The vibratory motor 405 with an out of balance weight at each end will run generally at 25 Hz in 50 Hz areas or at 15 or 30 Hz in 60 Hz areas. It will be appreciated that the angle between the top and bottom weights (as they meet the shaft axis) results in a vertical component of vibration, and hence vertical movement of the screen, and as the motor rotates it causes the screen to tilt. Vertical components of vibration can also be caused if the horizontal plane of action of the rotating weight is above or below (as in the example) the centre of gravity of the whole vibratory structure. The mass and/or positions of the weights may be adjusted to adjust the pattern of product movement on the screen surfaces 12a and 12b.

The secondary vibrators 2a and 2b impart vertical vibrations to their respective screens 12a and 12b, those vertical vibrations having frequencies which are below 400 Hz and adjustable. At these frequencies there is no question of any substantial resonance condition being set up on the screen surfaces. Instead, for each circular screen all points move substantially in phase with each other. The edge of each screen is, of course, constrained by its frame 14, whereas the centre of the screen (in this example) is at a position of maximum amplitude, being driven directly by the secondary vibrator 2. Thus, each screen experiences substantially cone-like deformations as it is vibrated by the secondary vibrator 2.

In this example, the primary vibrations generated by the motor 404 and weights 406, 408 (in conjunction with the spring mounts 110) have amplitudes of the order of a few millimetres. The secondary, vertical vibrations, have amplitudes in the range 100 microns to 1 mm.

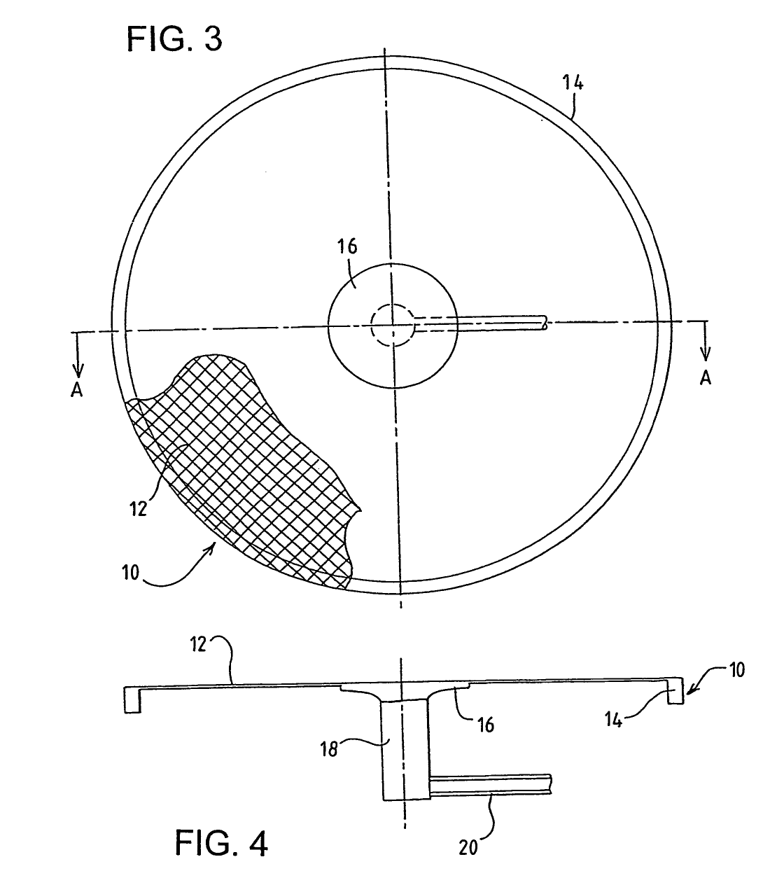

Referring to FIGS. 3 and 4, components of a sieving apparatus 10 embodying the invention are illustrated. The apparatus 10 includes a primary means of vibratory movement of the known kind generally described above, which for the sake of brevity, will not be described again here, and a secondary means of vibratory movement which will now be described.

The apparatus 10 has a sieving surface, in this case a mesh 12, radially tensioned in a frame 14 and held substantially horizontal. Secured to the mesh 12, by adhesive (not shown), or any other appropriate means such as clamping and bolting, is a vibration transmission member 16 to which is connected a pneumatic actuator 18 which is of known kind but will be described below. The transmission member or transmitter 16 in this embodiment takes the form of a flat round front face attached to the mesh 12 with a central circular flange on the rear face for connection of the pneumatic actuator 18. The pneumatic actuator 18 is driven by compressed air provided through supply pipe 20. The air will normally be supplied from a standard factory line pressure, which may be anything from zero up to 7×10⁵Nm⁻²(100 psi).

In use the pneumatic actuator 18 generates vibrations, as will be described below, which are transmitted to the transmitter 16, which in turn passes them to the mesh 12 which vibrates and moves the product being sieved around the surface thus helping to prevent sieve blinding, and to increase product through put.

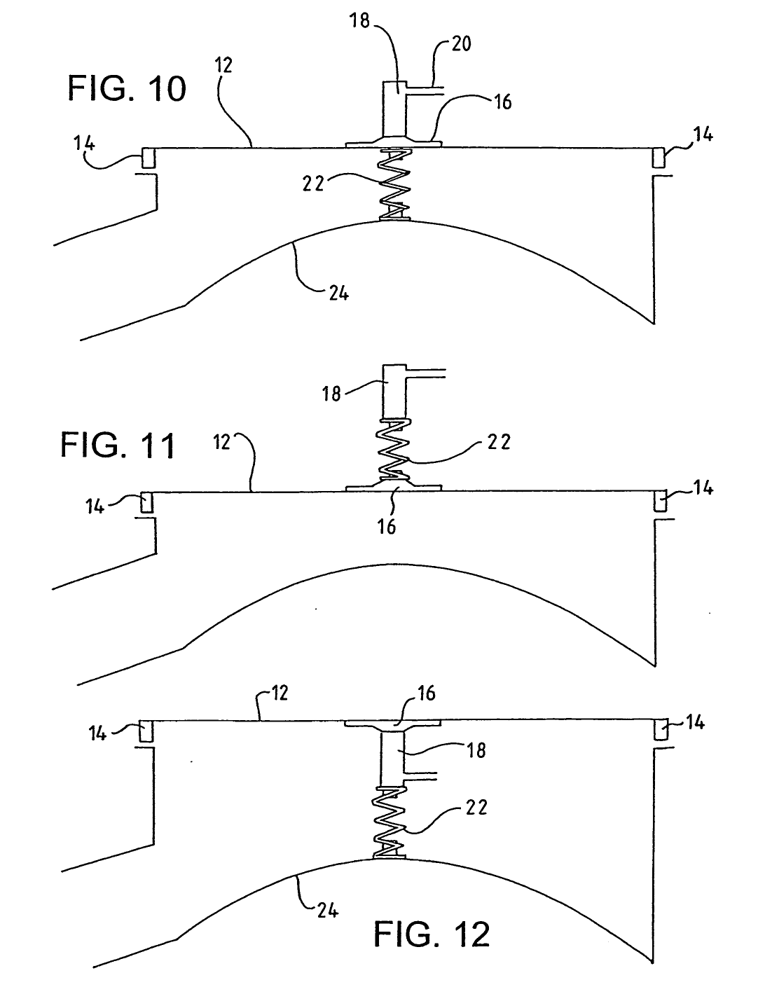

FIG. 10 shows a slight modification to the above described embodiment, in which like parts are like referenced. To assist in supporting the actuator 18 and transmitter 16, which in the embodiment of FIG. 10 are located above the mesh 12, a resilient element, which may for example be in the form of a spring 22, is located beneath the mesh 12 and is secured to part of the supporting structure 24 of the sieving apparatus. FIG. 11 shows a modification similar to FIG. 10, but with the spring 22 located between the actuator 18 and mesh 12.

In FIG. 12 a similar construction is shown in which the actuator 18 and spring 22 are located between the mesh 12 and the supporting structure 24.

It should be understood that the modifications illustrated in FIGS. 10, 11 and 12 are applicable to all forms of transmitter usable in the present invention.

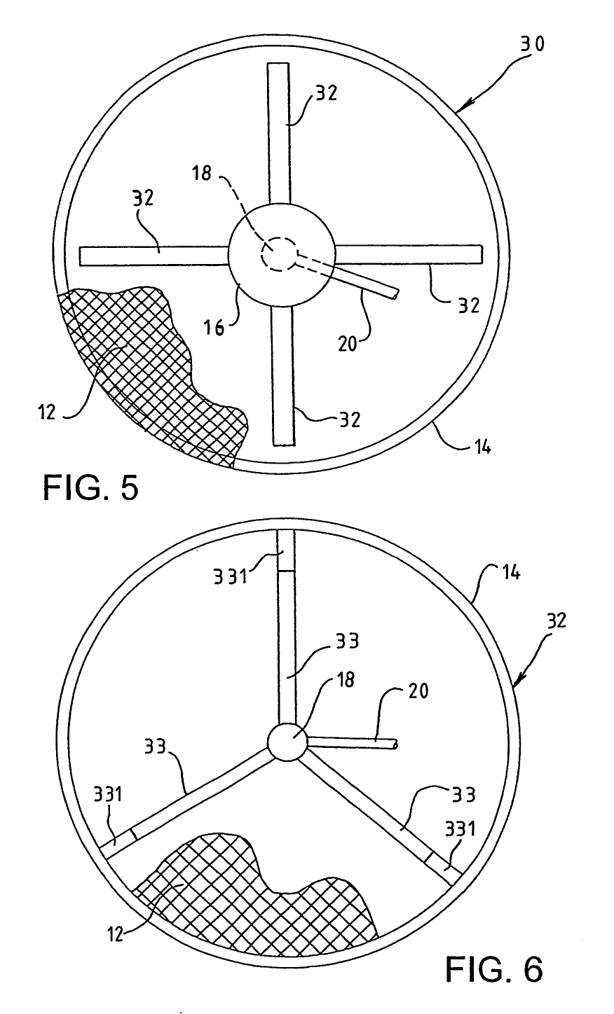

Transmitters for use in embodiments of the present invention may take other forms, and alternative transmitters are shown in FIGS. 5 to 9, in which parts common to FIGS. 3 and 4 are like referenced.

Apparatus 30, shown in FIG. 5, is similar to the apparatus 10, but with the addition of four extended rod-like elements 32 to the transmitter 16, to assist in activating the mesh over it's whole surface area. Other numbers of rod-like elements 32 may be added to the disc element 16 if desired, and they may be evenly spaced around the disc or otherwise arranged. In the example of FIG. 5 the rod-like elements 32 stop short of the screen frame 14. If the rod-like elements are rigid, and rigidly attached to the disc 16, then the gap between their ends and the frame 14 must be large enough so that the screen is not damaged as the transmitter moves relative to the frame 14.

Apparatus 32, as shown in FIG. 6, is similar to apparatus 30, but has no round portion to the transmitter just three rod like elements 33 extending from the actuator 18 towards the frame 14. In the Figure the rod like elements 33 are evenly spaced but they may be otherwise arranged, and there may be other numbers of such rod like elements. The elements 33 are rigid. However, resilient extension pieces 331 connect each element 33 to the frame in such a way as to provide some support for the transmitter and actuator (i.e. the second vibrator) from the frame. The lengths of the extension pieces 331 will, in general, be selected to suit the screen strength and amplitude of the secondary vibrations.

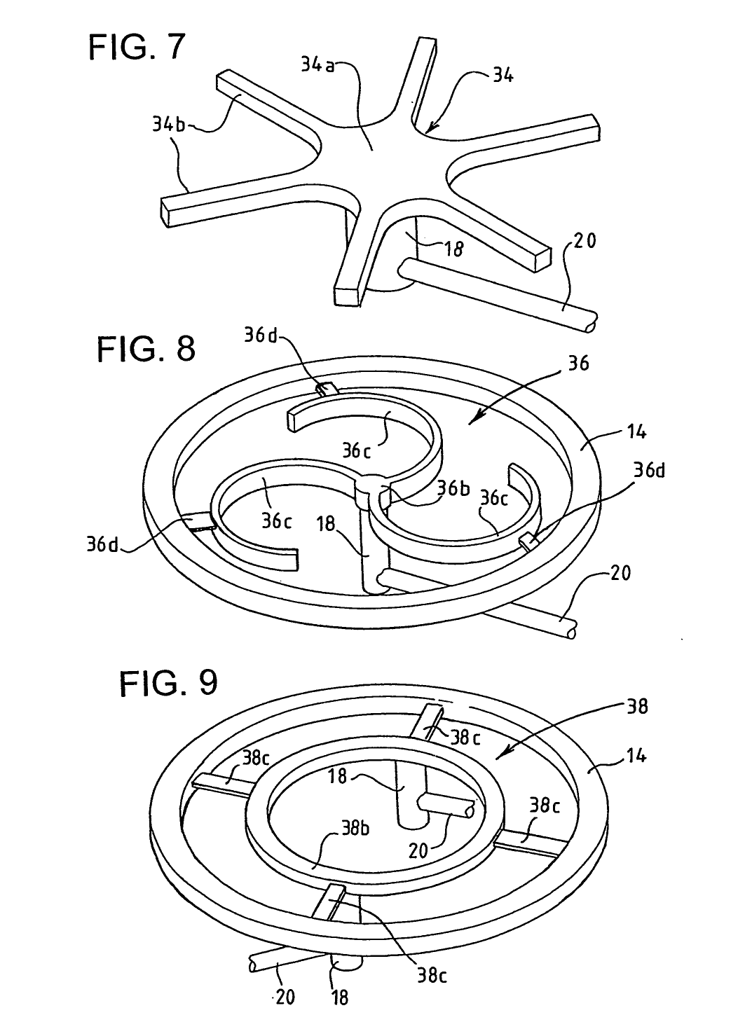

Transmitter 34, shown in FIG. 7, is a snow-flake shape with a central portion 34a and six evenly spaced integral rod-like parts 34b extending therefrom. A single pneumatic actuator 18 is secured to the central portion 34a. Further alternative transmitters similar to transmitter 34 may comprise other numbers of rod-like parts 34b and they may be arranged otherwise than equi-angularly.

FIG. 8 shows transmitter 36 which comprises a central element 36b with three equi-spaced curved elements 36c, and three support elements 36d (in the form of flexible webs) which secure the curved elements 36c to the annular screen frame 14. A single pneumatic actuator 18 is secured to the central element 36b.

Transmitter 38 is illustrated in FIG. 9, and has an inner annular element 38b arranged concentrically with respect to the annular frame 14. The inner annular element 38b is coupled to the annular frame 14 by means of four evenly spaced flexible support elements 38c. The transmitter 38 has secured it to two pneumatic actuators 18, diametrically opposite each other on the inner annular element 38b.

The transmitters 32, 34, 36 and 38 may be adhered to the mesh 12 by means of adhesive as for the transmitter 16. Alternatively, they may be adhered by any other appropriate means such as welding. As is apparent from FIGS. 6, 8 and 9, in embodiments of the invention the transmitters may be at least partially supported by means of physical connections to the frame 14 if necessary, particularly if they are too heavy to be supported by the mesh 12 without damage to it. Any physical connections to the frame must be flexible, or incorporate a flexible element, to ensure that the vibrations produced by the pneumatic actuator are not damped more than necessary.

The transmitters 16, 32, 34, 36 and 38 are conveniently formed from stainless steel, but may be formed from any appropriate material according to the environment in which they are to be used.

As is clear from the above descriptions there are many forms of transmitter which may be used in the second vibrator of the invention. Transmitters may be manufactured in a single piece, or may be constructed from two or more pieces. However, in the latter case, connections between the pieces must be sufficiently rigid to ensure good transmission of the vibrations.

Although the transmitters described above are circular, or based upon a circle, other shapes of transmitters may be used. For example transmitters may be square or rectangle, or based upon such basic shapes.

The size of transmitters will be determined by the size and strength of the mesh and frame assembly with which it is to be used. However, the transmitters will generally have dimensions in the range 100 mm to 2000 mm.

It will be apparent that in embodiments of the present invention the dimensions of the screens and transmitters are such that at the frequencies of the second vibrator (i.e. below 400 Hz) there is no question of either the screen or transmitter being in a resonant condition. At these frequencies, all parts of the screen and transmitter move substantially in phase with each other, although amplitude will depend on position relative to the frame.

In sieves embodying the invention transmitters may be driven by a single actuator 18, or by a plurality of them, as appropriate in each case. Further, more than one transmitter may be used on a single mesh and frame assembly if desired.

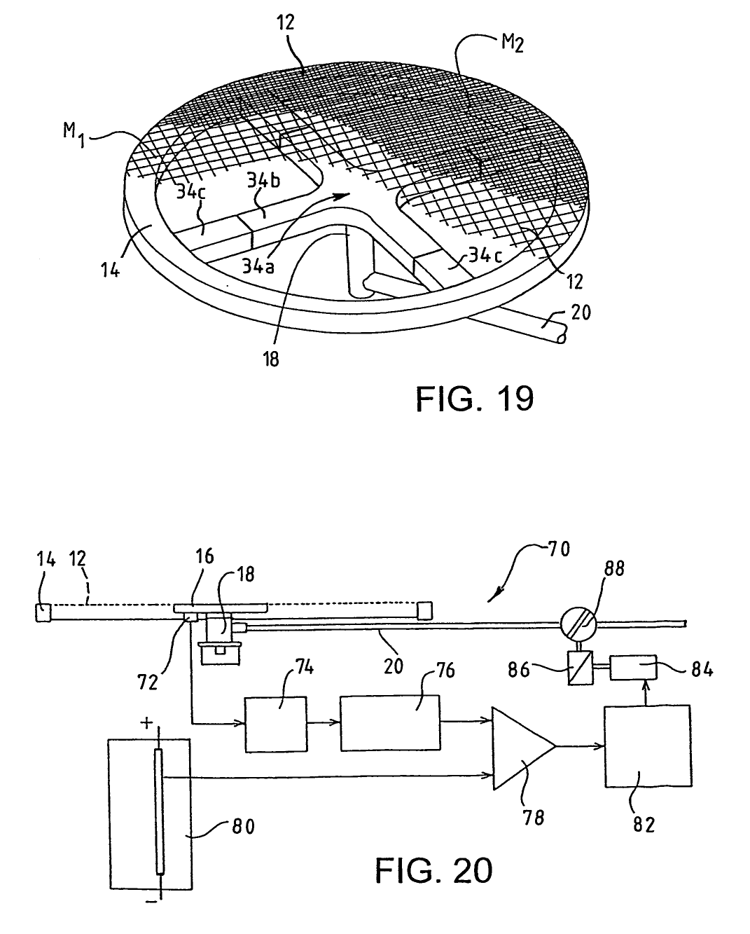

Embodiments of sieving apparatus according to the invention may also incorporate double meshes of the kind known in the prior art which have a first coarse mesh below a smaller finer mesh. In such embodiments, an example of which is shown in FIG. 19, the actuator 18 would be located beneath the first coarse mesh M₁, with a transmitter attached to that mesh and will drive the coarse mesh. The second finer mesh M₂ will then be driven by the first coarse mesh. Such embodiments are particularly suitable where the mesh required to achieve the appropriate result in sieving is extremely fine and too delicate to be driven directly. In some applications it may be appropriate to reverse the fine and coarse meshes such that the fine mesh is below the coarse mesh, and the fine mesh is driven directly and in turn drives the coarse mesh.

Of course, the mesh 12 or meshes M₁/M₂ need not be round as shown in the Figures but may be to any desired configuration, e.g. polygonal, rectangular or square, with the respective frame shaped accordingly.

In FIG. 19 the generally cruciform transmitter has a hub 34a, and radially extending arms which comprise an inner, rigid portion 34b and an outer flexible portion 34c connected to the mesh frame 14.

The sieving surfaces described above are all in the form of mesh which will typically be stainless steel mesh. However other forms of sieve screens may be used, such as sieving surfaces made from plate with holes therethrough. Typically this will be stainless steel plate with holes punched through it. Such plate may be used as the only layer of a sieving surface, or as one layer of a multi layer sieving surface either with other plates or with one or more mesh layers.

Synthetic mesh is another sieving surface suitable for use in embodiments of the invention.

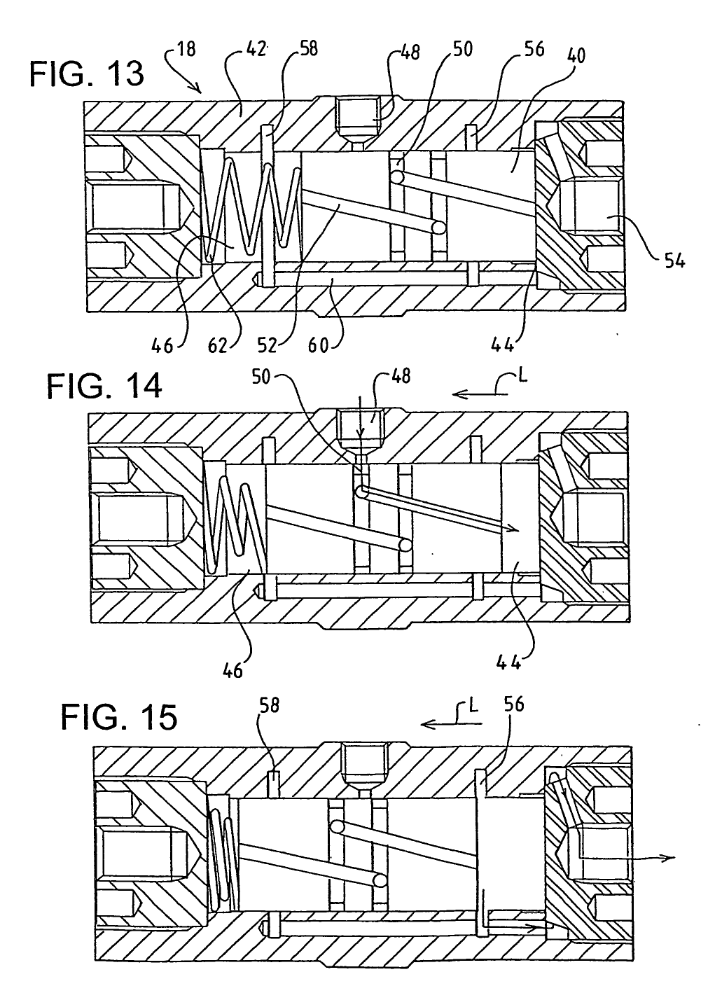

Referring now to FIG. 13 a pneumatic actuator 18 suitable for use in embodiments of the invention as the excitation source of the secondary vibrator will be described. The actuator 18 comprises a piston 40 moveable within a cylinder 42, defining a first space of variable volume 44 to the right of the piston as shown in FIG. 14, and a second space of variable volume 46 to the left of the piston as shown in FIG. 13. An inlet port 48 is provided in the side of the cylinder 42, and first and second inlet passages 50, 52 are provided through the piston 40 to the spaces 46 and 44 respectively.

The actuator 18 further comprises an exhaust port 54 located in the right hand end of the cylinder 42. Exhaust passages 56 and 58 are provided in the cylinder 42 which connect to the spaces 44, 46 respectively dependent upon the location of the piston 40. The exhaust passages 56, 58 connect to passage 60 which in turn connects to the exhaust port 54.

A compression spring 62 is located in the space 46, and when the actuator is not in use keeps the piston 40 at the rest position shown in FIG. 13. The spring 62 is of relatively low stiffness and hence has little if any effect on the operation of the actuator when in use.

The operation of the pneumatic actuator 18 will now be described with reference to FIGS. 13 to 18 which illustrate the piston 40 in different positions during the operation of the actuator 18, and which also show the relevant flow paths of the gas.

FIG. 14 shows the gas entering through the inlet port 48 and passing through the first inlet passage 50 to enter the first space 44, and to propel the piston 40 from the right to the left of the cylinder 42, as illustrated by arrow L.

As the piston 40 moves to the left, within the cylinder 42, exhaust passage 56 is connected to the first space 44 and the pressure in that space drops to atmospheric pressures, (FIG. 15). The momentum of the piston 40 carries it towards the left reducing the size of the second space 46. As the piston 40 moves the second exhaust passage 58 is closed off from the second space 46, and thus the pressure in the second space 46 then rises above atmospheric pressure with continued movement of the piston 40, such that it acts as a buffer. The movement of the piston 40 to the left also compresses the spring 62.

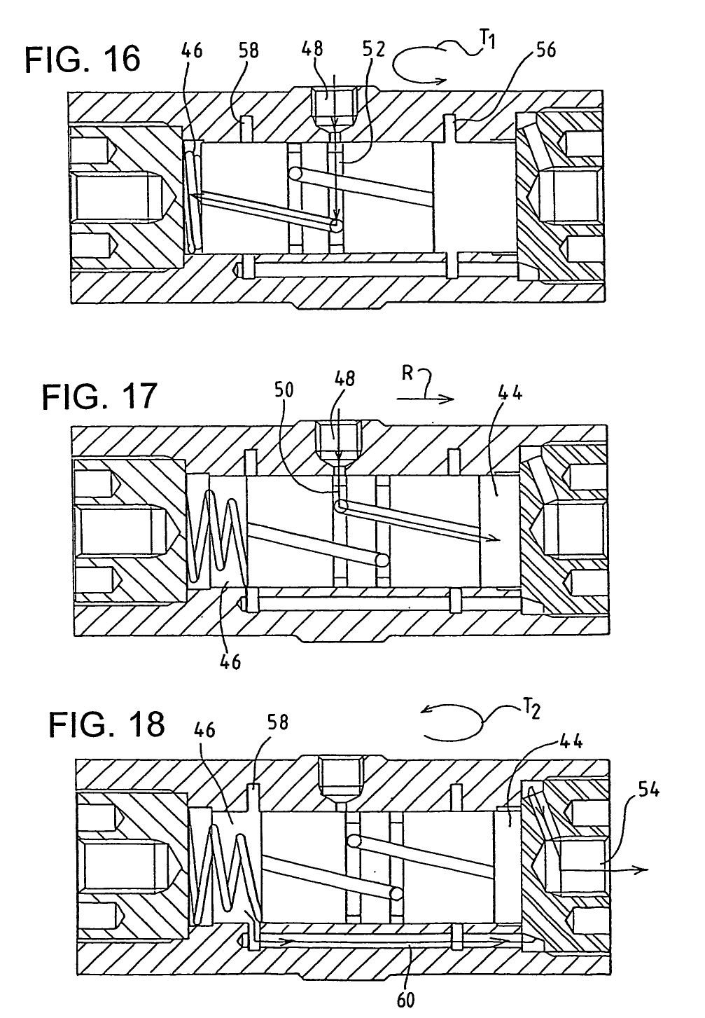

As the piston 40 approaches the left hand end of the cylinder 42, the second inlet passage 52 becomes connected to the second space 46 and gas flows into that space. This causes the piston 40 to stop and then reverse it's direction of movement, such that it them returns to the right, as shown by arrow T1 (FIG. 16), reducing the size of space 44. The movement of the piston 40 to the right is assisted slightly by the spring 62.

During the movement of the piston 40 to the right, as illustrated by arrow R, the exhaust port 56 is closed off from the space 44. Then the inlet port 48 lines up briefly with the first inlet passage 50 and gas passes through it into the first space 44 pressurising that space (FIG. 17). At this point both spaces 44 and 46 are pressurised, but the momentum of the piston 40 (as assisted slightly by the spring 62) ensures that it continues to move to the right.

The second exhaust passage 58 is then connected to the second space 46 bringing that space to atmospheric pressure. This causes the piston 40 to slow down and stop, and then to reverse its direction of movement back to the left, as shown by arrow T2 in FIG. 18. The process is repeated.

The reciprocating movement of the piston 40 within the cylinder 42 generates vibrations which are transmitted to activate the transmitter. The direction of the vibrations thus transmitted clearly depends upon the orientation at which the actuator 18 is secured to the transmitter. Generally this will be with the axis of movement of the piston substantially perpendicular to the mesh 12, but in some applications some lateral movement will be desired.

The frequency of the actuator 18 can be varied, by varying the pressure of the air supplied to it, from a few Hertz up to several hundred Hertz, depending on the application concerned. The correct frequency for any particular application is a matter of trial and error, as is well known to any experienced separation practitioner.

The excited vibration of the transmitter will generally be forced rather than resonant, and preferably in most applications avoids harmonics of the basic mesh and frame assembly frequency in order to avoid or limit damage to the assembly. However, in some circumstances sieving apparatus according to the invention may be operated at resonance rather than in forced vibration. The operation of the pneumatic actuator 18 may be continuous or pulsed, and may involve variation of the driving frequency.

However, the vibration of the actuator, transmitter and mesh may be maintained at a desired frequency by means of a control circuit.

The magnitude of vibration of the transmitter may be controlled in order to prevent the build up of amplitude and damage to the apparatus. An appropriate circuit 70 is illustrated in FIG. 20. The circuit 70 includes a vibration sensor 72 attached to the transmitter 16 such that it senses the vibrations thereof. The output from the sensor 72 passes through a filter 74 which removes vibrations in frequency ranges outside the range of the pneumatic actuator 18. It is preferable if the frequency range in which the actuator operates does not overlap with the frequency range of the primary sieve motor if any. From the filter the signal passes via a rectifier 76 to form one input to a servo amplifier 78.

The desired vibration level is set by means of an activity demand controller 80, the output from which forms the second input to the servo amplifier 78. The output from the servo amplifier 78 passes to a motor drive 82 the output from which drives a motor 84. The motor 84 in turn drives a gearbox 86 which is used to control a control valve 88 located in the air supply line 20.

The circuit 70 operates as follows. The output from the activity demand controller 80 is compared in the servo amplifier 78 with the output from the filter 74 after rectification. Any discrepancy is amplified and used to drive the motor 84, which turns the air control valve 88 via the gearbox 86 such as to reduce the sensed discrepancy in vibration by increasing or decreasing the air flow as required.

If it is desired to pulse the vibration then a solenoid valve may be included in the air supply line 20 to enable the supply to be switched on and off at the desired frequency. Control of such a valve is simple and will not be described in the interests of brevity.

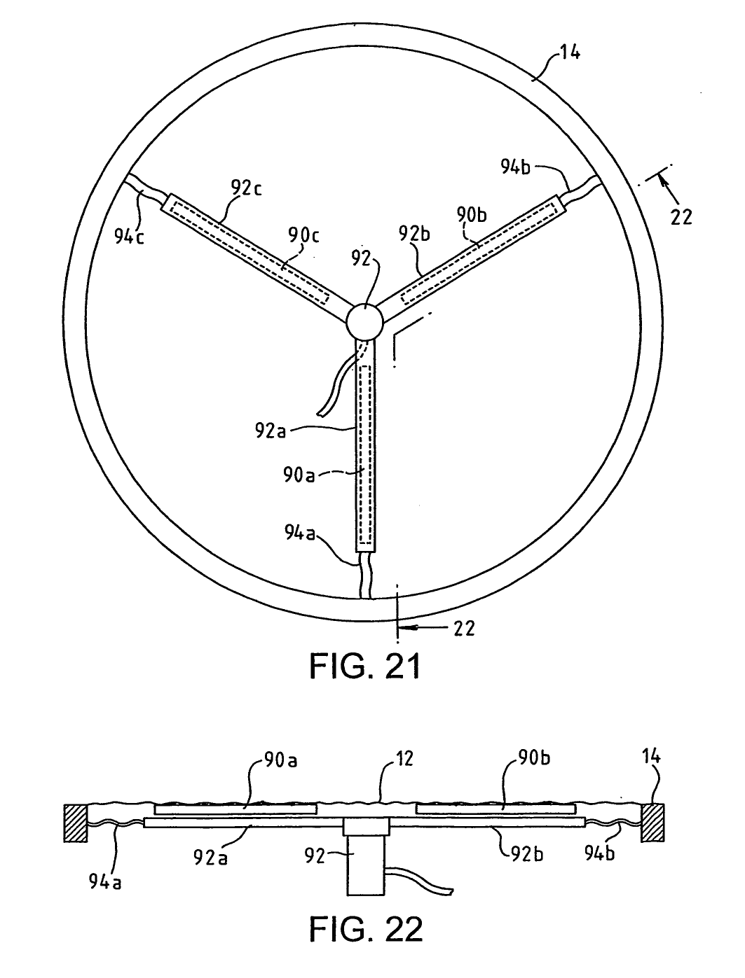

In the examples of the invention described above, the excitation source of the secondary vibrator has been attached to the vibration transmission member so that the vibration transmission member is activated by direct transmission of vibrations from the excitation source. FIGS. 21 and 22 illustrate an alternative arrangement in which the excitation source is not attached to the vibration transmission member.

In FIGS. 21 and 22, vibration transmission members 90a, 90b and 90c are bonded beneath a circular mesh 12 radially tensioned on a frame ring 14. The transmission members 90a, 90b and 90c are, in this example, elongate rods which are arranged radially as illustrated in FIG. 21. In FIG. 21, the transmission members are shown in dotted outline since they are obscured from beneath the screen 12 by radially extending parts 92a, 92b and 92c of an actuator 92 which constitutes the excitation source of the secondary vibrator of the sieve. The actuator 92 may for example be a pneumatic actuator having the same structure as described above and in particular with respect to FIGS. 13 to 18.

The actuator 92 is supported by means of relative flexible connections 94a, 94b and 94c between the radially outer ends of the radial parts 92a, 92b and 92c and the frame ring 14. The connections 94a, 94b and 94c are typically formed of thinner metal welded at each end to the respective radial arm of the actuator 92 and to the frame ring 14. The connections are designed to carry the weight of the actuator 92 whilst at the same time allowing the actuator 92 to vibrate as a whole in a substantially vertical direction so that the arms 92a, 92b and 92c repeatedly strike the vibration transmission members 90a, 90b and 90c, whereby vertical vibrations are imparted to the sieve screen 12 relative to the frame 14.

Instead of being supported by the connections 94a, 94b and 94c as illustrated, the actuator 92 may be supported by the flexible spring arrangements illustrated in FIGS. 10 to 12, arranged to permit vertical vibratory movement of the actuator 92, but to restrict horizontal movement of the actuator which might be induced by the main vibratory action of the sieve screen caused by the primary vibrator (not shown in FIGS. 21 and 22).

Importantly, because the vibration transmission members 90a, 90b and 90c are directly attached to the sieve screen 12, the secondary vibrator does not cause any wear directly on the sieve screen 12, e.g. by rubbing on the screen.

Although the examples of the invention described above employ a pneumatic actuator the invention may also be put into practice with many other forms of actuator. For example a reciprocating mass actuator may be electromechanical rather than pneumatic, with the two electromagnets, one at either end of the mass (i.e. piston), being switched to provide the movement and hence vibration. Actuators of this kind are known in many applications, both domestic and industrial, for example bells, electric razors, small powder feeders and vibratory feeders. Other forms of actuator may incorporate rotating out of the balance weights powered by air or electricity, or electrically actuated moving coils as in most forms of loud speaker.

Although certain embodiments according to the invention described above incorporate a control circuit, provided to assist the apparatus in operating at a desired frequency, embodiments of sieving apparatus in accordance with the invention need not includes such a control circuit.

Embodiments according to the invention which include a plurality of actuators, such as is shown in FIG. 9, may be operated with the actuators at the same frequency or at different frequencies.

In the examples of the invention described above, the screen is tensioned in at least two orthogonal directions and in particular radially for a circular screen. However, untensioned screens may be employed which are substantially only supported in the screen frame without significant tension in the plane of the screen.

1. A sieve comprising:
a base;
a sieve screen frame;
a sieve screen mounted in the frame so as to be substantially horizontal;
a first vibrator arranged to vibrate the frame relative to the base in a horizontal direction and at a first frequency; and
a second vibrator having a vibration transmission member attached directly to the sieve screen and an excitation source arranged to activate said vibration transmission member so as to vibrate the sieve screen relative to the frame in a substantially vertical direction and at a second frequency,
the first and second frequencies being less than 400 Hz.

2. A sieve in accordance with claim 1, wherein the first and second frequencies are different from one another.

3. A sieve in accordance with claim 2, wherein the second frequency is not a harmonic of the first.

4. A sieve in accordance with claim 2, wherein the first frequency is not a harmonic of the second.

5. A sieve in accordance with claim 1, wherein the second frequency is higher than the first.

6. A sieve in accordance with claim 5 wherein the second frequency is higher than the first by at least approximately an order of magnitude.

7. A sieve in accordance with claim 1, wherein at least one of the first and second frequencies is adjustable.

8. A sieve in accordance with claim 1, wherein the first vibrator is arranged to vibrate the frame relative to the base primarily in a horizontal direction and with a first amplitude, the second vibrator is arranged to vibrate the sieve screen relative to the frame with a second amplitude, and the first and second amplitudes are different from one another.

9. A sieve in accordance with claim 8, wherein the second amplitude is smaller than the first.

10. A sieve in accordance with claim 9, wherein the second amplitude is smaller than the first by at least approximately one order of magnitude.

11. A sieve in accordance with claim 8, wherein at least one of the first and second amplitudes is adjustable.

12. A sieve in accordance with claim 1, wherein the second vibrator comprises a pneumatic actuator.

13. A sieve in accordance with claim 1, wherein the second vibrator comprises an electrically powered actuator.

14. A sieve in accordance with claim 1, wherein the second vibrator comprises an actuator including a rotating weight.

15. A sieve in accordance with claim 1, wherein the second vibrator comprises an actuator including a reciprocating weight.

16. A sieve in accordance with claim 1, wherein the excitation source is attached to the vibration transmission member.

17. A sieve in accordance with claim 1, wherein the excitation source is not attached to the vibration transmission member and has a striking surface arranged to strike the vibration transmission member when the source is energised.

18. A sieve in accordance with claim 1, wherein the excitation source is not attached to the vibration transmission member and has a contact surface arranged to apply pressure to the vibration transmission member to communicate vibrations to said member when the source is energised.

19. A sieve in accordance with claim 17, wherein the vibration transmission member comprises at least one bar secured to the screen.

20. A sieve in accordance with claim 16, wherein the transmission member comprises a circular portion with a planar face secured to the sieve screen.

21. A sieve in accordance with claim 18, wherein the excitation source is rigidly coupled to the frame.

22. A sieve in accordance with claim 1, wherein the second vibrator comprises a plurality of excitation sources.

23. A sieve in accordance with claim 1, wherein the sieve screen comprises a first screen and a second screen arranged above and supported by the first screen, the second vibrator being operative to vibrate at least one of the first and second screens.

24. A sieve in accordance with claim 23 wherein the first screen is coarser than the second screen and the vibration transmission member is attached to first screen.

25. A sieve in accordance with claim 23, wherein the first and second screens are arranged such that one is directly vibrated by the second vibrator and the other is vibrated by contact with the directly vibrated screen.

26. A sieve in accordance with claim 1, wherein the first vibrator comprises at least one rotating out-of-balance weight.

27. A sieve in accordance with claim 1, wherein the or each screen frame is circular.

28. A sieve in accordance with claim 1, wherein the sieve screen is tensioned by the frame in at least two orthogonal directions.

29. A sieve in accordance with claim 27, wherein the sieve screen is radially tensioned in the frame.
